(19) United States
(12) Patent Application Publication
(10) Pub. No.: US 2022/0057626 A1
(43) Pub. Date: Feb. 24, 2022

(54) MEMS SCANNING MIRROR WITH PIEZOELECTRIC DRIVE MECHANISM

(71) Applicant: Beijing Voyager Technology Co., Ltd., Beijing (CN)

(72) Inventors: Youmin Wang, Mountain View, CA (US); Yufeng Wang, Mountain View, CA (US); Gary Li, Mountain View, CA (US)

(21) Appl. No.: 17/001,038

(22) Filed: Aug. 24, 2020

(51) Int. Cl. G02B 26/08; G02B 26/10; G01S 7/481; G01S 17/931

(52) U.S. Cl. CPC G02B 26/0858; G01S 17/931; G01S 7/4817; G02B 26/101

(57) ABSTRACT

A LiDAR module for a vehicle includes a semiconductor integrated circuit including a MEMS having a substrate, a first piezoelectric actuator coupled to the substrate, a second piezoelectric actuator coupled to the substrate; and a mirror structure configured between the first and second piezoelectric actuators. The mirror structure is planar and includes: a first edge defining the length of the mirror structure, wherein the first edge is coupled to the first piezoelectric actuator via a first set of connection springs; a second edge defining the length of the mirror structure and opposing the first edge, wherein the second edge is coupled to the second piezoelectric actuator via a second set of connection springs, wherein the mirror structure is configured to oscillate on an axis of rotation that is parallel to and equidistant from the first and second edges of the mirror structure.

### CROSS-REFERENCES TO RELATED APPLICATIONS

The following U.S. patent applications listed below (which include the present application) are being filed concurrently, and the entire disclosures of the other applications are hereby incorporated by reference into this application for all purposes:
application Ser. No. ______, filed Aug. 24, 2020, and entitled “Structures for Piezoelectric Actuator to Increase Displacement and Maintain Stiffness” (Attorney Docket No. 103343-1186154-004000U5);
application Ser. No. ______, filed Aug. 24, 2020, and entitled “MEMS Scanning Mirror With Piezoelectric Drive Mechanism” (Attorney Docket No. 103343-1186147-003600US); and
application Ser. No. ______, filed Aug. 24, 2020, and entitled “Piezoelectric-Actuated Micro-Mirror With No Torsional Beam” (Attorney Docket No. 103343-1186150-003700US).

### BACKGROUND

Modern vehicles are often equipped with sensors designed to detect objects and landscape features around the vehicle in real-time to enable technologies such as lane change assistance, collision avoidance, and autonomous driving. Some commonly used sensors include image sensors (e.g., infrared or visible light cameras), acoustic sensors (e.g., ultrasonic parking sensors), radio detection and ranging (RADAR) sensors, magnetometers (e.g., passive sensing of large ferrous objects, such as trucks, cars, or rail cars), and light detection and ranging (LiDAR) sensors.

A LiDAR system typically uses a light source and a light detection system to estimate distances to environmental features (e.g., pedestrians, vehicles, structures, plants, etc.). For example, a LiDAR system may transmit a light beam (e.g., a pulsed laser beam) to illuminate a target and then measure the time it takes for the transmitted light beam to arrive at the target and then return to a receiver near the transmitter or at a known location. In some LiDAR systems, the light beam emitted by the light source may be steered across a two-dimensional or three-dimensional region of interest according to a scanning pattern, to generate a “point cloud” that includes a collection of data points corresponding to target points in the region of interest. The data points in the point cloud may be dynamically and continuously updated, and may be used to estimate, for example, a distance, dimension, location, and speed of an object relative to the LiDAR system.

Light beam steering techniques can also be used in other optical systems, such as optical display systems (e.g., TVs), optical sensing systems, optical imaging systems, and the like. In various light beam steering systems, the light beam may be steered by, for example, a rotating platform driven by a motor, a multi-dimensional mechanical stage, a Galvo-controlled mirror, a resonant fiber, an array of microelectromechanical (MEMS) mirrors, or any combination thereof. A MEMS micro-mirror may be rotated around a pivot or connection point by, for example, a micro-motor, an electromagnetic actuator, an electrostatic actuator, or a piezoelectric actuator. Despite the many improvements in MEMS micro-mirror-based systems, new solutions are needed for systems that utilize larger aperture mirrors to better address the engineering challenges they present.

### SUMMARY

Techniques disclosed herein relate generally to microelectromechanical (MEMS) mirrors that can be used in, for example, light detection and ranging (LiDAR) systems or other light beam steering systems. More specifically, and without limitation, disclosed herein are MEMS micro-mirrors including piezoelectric actuators that include structures to achieve a large displacement while maintaining a high stiffness, thereby achieving a large scanning angle (and thus a large field of view) and a high resonant frequency (and thus a high resolution). Various inventive embodiments are described herein, including systems, modules, devices, components, circuits, materials, methods, and the like.

According to certain embodiments, a Light Detection and Ranging (LiDAR) module for a vehicle comprises a semiconductor integrated circuit including a microelectromechanical system (MEMS), the MEMS including a substrate, a first piezoelectric actuator coupled to the substrate, a second piezoelectric actuator coupled to the substrate, and a mirror structure configured between the first piezoelectric actuator and the second piezoelectric actuator. The mirror structure can be planar, having a length and a width, and including a first edge defining the length of the mirror structure, wherein the first edge is coupled to the first piezoelectric actuator via a first set of connection springs; a second edge defining the length of the mirror structure and opposing the first edge, wherein the second edge is coupled to the second piezoelectric actuator via a second set of connection springs; a third edge defining the width of the mirror structure; and a fourth edge defining the width of the mirror structure and opposing the third edge, wherein the mirror structure is configured to oscillate on an axis of rotation that is parallel to and equidistant from the first and second edges of the mirror structure. The mirror structure can comprise a mirror and a gimbal coupled to the mirror via a set of connection structures, wherein the gimbal is configured concentrically around and coplanar with the mirror, wherein when rotated, the gimbal causes the mirror to rotate, wherein the first and second edges of the mirror structure are part of the gimbal.

In some aspects, each connection spring in the first set of connection springs is co-planar with the mirror structure and may include: a first section protruding from the first edge of the mirror structure in a direction normal to the axis of rotation and oriented towards the first piezoelectric actuator; a second section protruding from the first piezoelectric actuator in a direction normal to the axis of rotation, not collinear with the first section, and oriented towards the mirror structure; and a third section configured parallel to the axis of rotation that couples the first section to the second section. In some embodiments, each connection spring in the second set of connection springs is co-planar with the mirror structure and includes a first section protruding from the second edge of the mirror structure in a direction normal to the axis of rotation and oriented towards the second piezoelectric actuator; a second section protruding from the second piezoelectric actuator in a direction normal to the axis of rotation, not collinear with the first section protruding from the second edge of the mirror structure, and oriented towards the mirror structure; and a third section configured parallel to the axis of rotation that couples the first section protruding from the second edge of the mirror structure to the second section protruding from the second piezoelectric actuator.

In some implementations, the first edge of the mirror structure has a first end, a second end, and a center portion between the first and second ends, wherein the second section is configured closer to the first end or the second end than the first section. The first edge of the mirror structure can have a first end, a second end, and a center portion between the first and second ends, wherein the first section is configured closer to the first end or the second end than the second section. Some embodiments may include at least two torsion springs coupled to diametrically opposed ends of the mirror structure along the axis of rotation, wherein the torsion springs are configured to apply a rotational force to the mirror structure that causes the mirror structure to oscillate. In some cases, the at least two torsion springs are each coupled to an anchor structure, the anchor structure being coupled to the substrate.

In certain embodiments, a Light Detection and Ranging (LiDAR) module for a vehicle can include a semiconductor integrated circuit including a microelectromechanical system (MEMS), the MEMS including: a substrate, a first piezoelectric actuator coupled to the substrate, a second piezoelectric actuator coupled to the substrate, and a mirror structure configured between the first piezoelectric actuator and the second piezoelectric actuator. In some cases, the mirror structure can be planar, having a length and a width, and may include a first edge defining the length of the mirror structure, a second edge defining the length of the mirror structure and opposing the first edge, a third edge defining the width of the mirror structure, wherein the third edge is coupled to the first piezoelectric actuator via a first set of connection springs, and a fourth edge defining the width of the mirror structure and opposing the third edge, wherein the fourth edge is coupled to the second piezoelectric actuator via a second set of connection springs, wherein the mirror structure is configured to oscillate on an axis of rotation that is parallel to and equidistant from the first and second edges of the mirror structure, and normal to the third and fourth edges of the mirror structure. The mirror structure can include a mirror and a gimbal coupled to the mirror via a set of connection structures, wherein the gimbal is configured concentrically around and coplanar with the mirror, wherein when rotated, the gimbal causes the mirror to rotate, wherein the third and fourth edges of the mirror structure are part of the gimbal.

In some implementations, each connection spring in the first set of connection springs is co-planar with the mirror structure and includes a first section protruding from the third edge of the mirror structure in a direction parallel to and not collinear with the axis of rotation and oriented towards the first piezoelectric actuator, and a second section protruding from the first piezoelectric actuator in a direction normal to the axis of rotation that couples to an end portion of the first section protruding from the third edge of the mirror structure. Each connection spring in the second set of connection springs is co-planar with the mirror structure and may includes a first section protruding from the fourth edge of the mirror structure in a direction parallel to and not collinear with the axis of rotation and oriented towards the second piezoelectric actuator, and a second section protruding from the second piezoelectric actuator in a direction normal to the axis of rotation that couples to an end portion of the first section protruding from the fourth edge of the mirror structure. The second section can couple to the first piezoelectric actuator at a location where the first edge and third edge of the mirror structure meet. In some aspects, the third edge of the mirror structure has a first end, a second end, and a center portion between the first and second ends of the third edge, wherein the second section couples to the first piezoelectric actuator at a location closer to the center portion than to the first or second ends of the third edge. The LiDAR module can further include at least two torsion springs coupled to diametrically opposed ends of the mirror structure along the axis of rotation, wherein the torsion springs are configured to apply a rotational force to the mirror structure that causes the mirror structure to oscillate. In some cases, the at least two torsion springs are each coupled to an anchor structure, the anchor structure being coupled to the substrate.

In further embodiments, a Light Detection and Ranging (LiDAR) module for a vehicle can comprise a semiconductor integrated circuit including a microelectromechanical system (MEMS), the MEMS including: a substrate, a first piezoelectric actuator coupled to the substrate, a second piezoelectric actuator coupled to the substrate, and a mirror structure configured between the first piezoelectric actuator and the second piezoelectric actuator. The mirror structure can be being planar, having a length and a width, and including: a first edge defining the length of the mirror structure, wherein the first edge is coupled to the first piezoelectric actuator via a first set of connection springs; a second edge defining the length of the mirror structure and opposing the first edge; a third edge defining the width of the mirror structure; and a fourth edge defining the width of the mirror structure and opposing the third edge, wherein the fourth edge is coupled to the second piezoelectric actuator via a second set of connection springs, and wherein the mirror structure is configured to oscillate on an axis of rotation that is parallel to and equidistant from the first and second edges of the mirror structure, and normal to the third and fourth edges of the mirror structure.

In some implementations, each connection spring in the first set of connection springs is co-planar with the mirror structure and includes: a first section protruding from the first edge of the mirror structure in a direction normal to the axis of rotation and oriented towards the first piezoelectric actuator; a second section protruding from the first piezoelectric actuator in a direction normal to the axis of rotation, not collinear with the first section, and oriented towards the mirror structure; and a third section configured parallel to the axis of rotation that couples the first section to the second section for each connection spring of the first set of connection springs, and wherein each connection spring in the second set of connection springs is co-planar with the mirror structure and includes: a first section protruding from the fourth edge of the mirror structure in a direction parallel to and not collinear with the axis of rotation and oriented towards the second piezoelectric actuator; and a second section protruding from the second piezoelectric actuator in a direction normal to the axis of rotation that couples to an end portion of the first section protruding from the fourth edge of the mirror structure. The LiDAR module may further include at least two torsion springs coupled to diametrically opposed ends of the mirror structure along the axis of rotation, wherein the torsion springs are configured to apply a rotational force to the mirror structure that causes the mirror structure to oscillate. In some embodiments, the at least two torsion springs can be each coupled to an anchor structure, the anchor structure being coupled to the substrate.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

Aspects and features of the various embodiments will be more apparent by describing examples with reference to the accompanying drawings, in which like reference numerals refer to like components or parts throughout the drawings.

FIG. 1 shows an example of a vehicle including a light detection and ranging (LiDAR) system, according to certain embodiments.

FIG. 2 shows a simplified block diagram of an example of a LiDAR system, according to certain embodiments.

FIGS. 3A and 3B shows an example of a LiDAR system according to certain embodiments. FIG. 3A shows an example of a beam steering operation by the LiDAR system according to certain embodiments. FIG. 3B shows an example of a returned beam detection operation by the LiDAR system, according to certain embodiments.

FIG. 4 shows a simplified diagram of an example of an optical subsystem in a LiDAR system, according to certain embodiments.

FIG. 5A shows an example of a rotatable micro-mirror assembly, according to certain embodiments.

FIG. 5B shows a cross-sectional view of the example of the rotatable micro-mirror assembly, as shown in FIG. 5A.

FIG. 6A shows an example of a rotatable micro-mirror assembly including piezoelectric actuators, according to certain embodiments.

FIG. 6B shows an example of an operating condition of the example of a rotatable micro-mirror assembly, as shown in FIG. 6A.

FIG. 7 shows another example of a rotatable micro-mirror assembly including piezoelectric actuators, according to certain embodiments.

FIG. 8 shows a simplified plan view of a MEMS-based mirror structure with piezoelectric actuators, according to certain embodiments.

FIG. 9 shows a close up view of a quadrant of a MEMS-based mirror structure driven by piezoelectric actuators with a first type of connection spring, according to certain embodiments.

FIG. 10 shows a close up view of a quadrant of a MEMS-based mirror structure driven by piezoelectric actuators with a second type of connection spring, according to certain embodiments.

FIG. 11 shows a close up view of a quadrant of a MEMS-based mirror structure driven by piezoelectric actuators with a third type of connection spring, according to certain embodiments.

FIG. 12 shows a close up view of a quadrant of a MEMS-based mirror structure driven by piezoelectric actuators with a fourth type of connection spring, according to certain embodiments.

FIG. 13 shows a close up view of a quadrant of a MEMS-based mirror structure driven by piezoelectric actuators with multiple types of connection springs, according to certain embodiments.

FIG. 14 is a graph showing a frequency response of a MEMS-based mirror structure driven by a piezoelectric actuator system, according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

### DETAILED DESCRIPTION

Aspects of the present disclosure relate generally to LiDAR systems, and more particularly to MEMS micro-mirror devices, according to certain embodiments.

In the following description, various examples of MEMS-based micro-mirror structures are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

The following high level summary is intended to provide a basic understanding of some of the novel innovations depicted in the figures and presented in the corresponding descriptions provided below. Techniques disclosed herein relate generally to micro-mirrors, such as microelectromechanical (MEMS) mirrors, that can be used in light beam steering systems, such as light detection and ranging (LiDAR) systems. More specifically, and without limitation, disclosed herein are LiDAR systems with piezoelectric actuators for rotating MEMS-based micro-mirrors. The piezoelectric actuators include various novel structures (e.g., connection springs) that allow the micro-mirror to achieve a large displacement and maintain a high stiffness, thereby achieving a large range of light scanning angles (and thus a large field of view) and a high resonant frequency (and therefore a high resolution). Various inventive embodiments are described herein, including systems, modules, devices, components, circuits, materials, methods, code, or instructions executable by one or more processors, and the like.

A light steering system, such as a LiDAR system, may include a transmitter subsystem that transmits and scans light beams (e.g., infrared light beams), and/or a receiver subsystem that receives and scans light beams from objects (e.g., people, animals, and automobiles) and environmental features (e.g., trees and building structures). For example, a LiDAR system carried by a vehicle may be used to determine the vehicle's relative position, speed, and direction with respect to other objects or environmental features based on a point cloud generated by the LiDAR system, and thus may, in some cases, be used for autonomous driving, auto-piloting, driving assistance, parking assistance, collision avoidance, and the like.

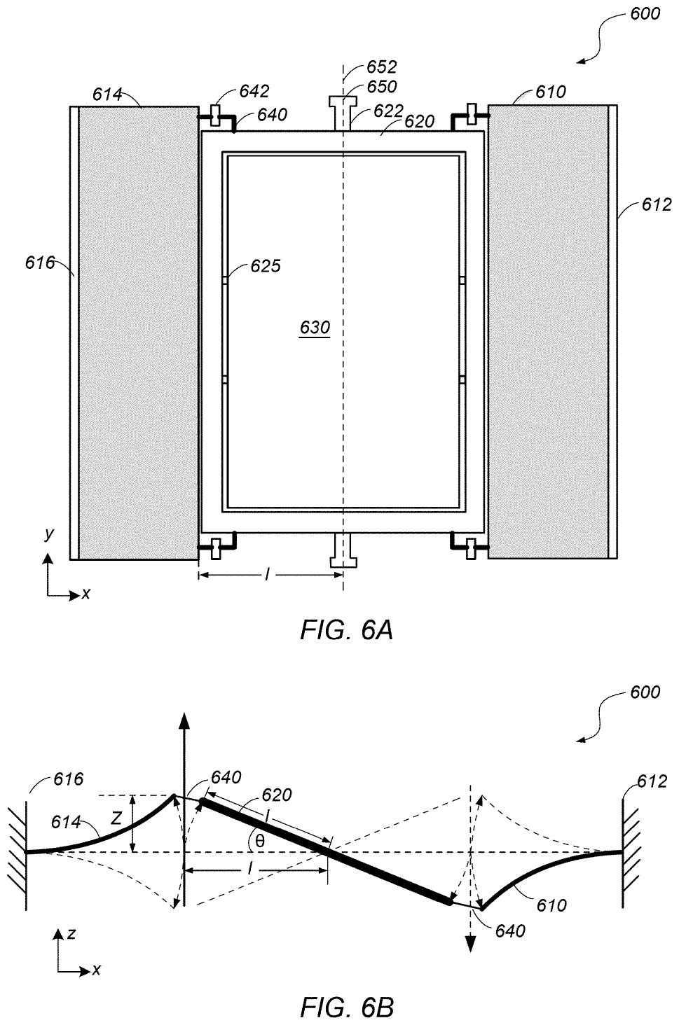

In some light steering systems, the transmitted or received light beam may be steered by an array of micro-mirrors. Each micro-mirror may rotate around a pivot or connection point to deflect light incident on the micro-mirror to desired directions. The performance of the micro-mirrors may directly affect the performance of the light steering system, such as the field of view (FOV), the quality of the point cloud, and the quality of the image generated using a light steering system. For example, to increase the detection range and the FOV of a LiDAR system, micro-mirrors with large rotation angles and large apertures may be used, which may cause an increase in the maximum displacement and the moment of inertia of the micro-mirrors. To achieve a high resolution, a device with a high resonant frequency may be used, which may be achieved using a rotating structure with a high stiffness. It may be difficult to achieve this desired performance using electrostatic actuated micro-mirrors because comb fingers used in an electrostatic-actuated micro-mirror may not be able to provide the force and moment needed and may disengage at large rotation angles, in particular, when the aperture of the micro-mirror is increased to improve the detection range. Some piezoelectric actuators may be able to achieve large displacements and large scanning angles due to its ability to provide a substantially larger drive force than electrostatic-actuated types, with a relatively lower voltage. However, piezoelectric actuators are not widely used because they can be more sensitive to temperature variation than their electrostatic counterparts, which can adversely affect performance and uniformity across an array of mirrors. Aspects of the invention incorporate novel connection springs that couple the piezoelectric actuator to the mirror structure (e.g., gimbal and mirror) that operate to materially reduce the deleterious effects of temperature variation and relieve stress on the piezoelectric actuators. Different variations of the connection springs are shown and described below in the description that follows, for example in FIGS. 6-11.

A conceptual overview (e.g., description before the discussion of individual figures in detail) of certain embodiments of MEMS-based micro-mirror systems include one or more piezoelectric actuators that can address the problems described above are provided herein. This overview is not intended to identify key or essential features of the figures or the claimed subject matter, nor is it intended to be used in isolation to determine the scope of the claimed subject matter. Each figure referred to in this overview is further described below in greater detail and for broader application.

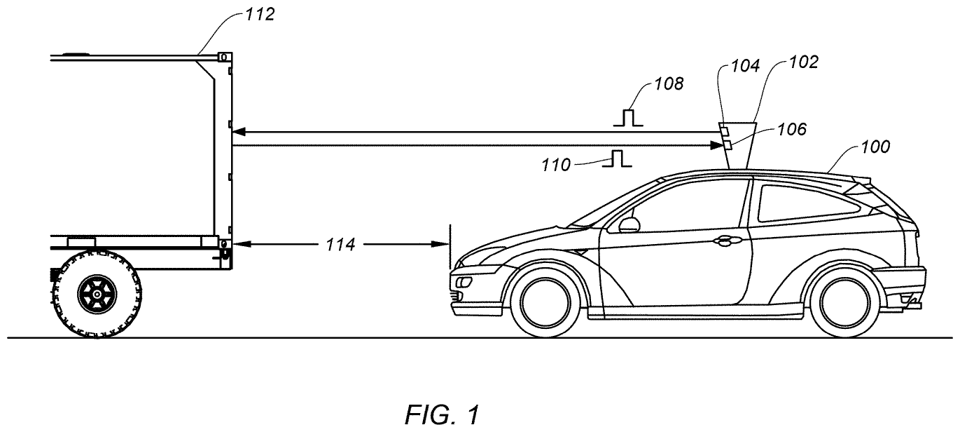

Presenting the conceptual overview, MEMS-based micro-mirrors disclosed herein can be configured to perform light steering in various examples of light steering systems, such as those shown and described below in detail with respect to FIGS. 1-4. For instance, the MEMS-based micro-mirrors systems described herein can be a part of a transmitter configured to control a scanning angle of a transmitted light beam or part of a receiver configured to select an angle of returned light beam for object detection. Some embodiments may employ a coaxial configuration such that the light steering system can project output light to a location and receive returned light reflected from the same location, as would be appreciated by one of ordinary skill in the art with the benefit of this disclosure.

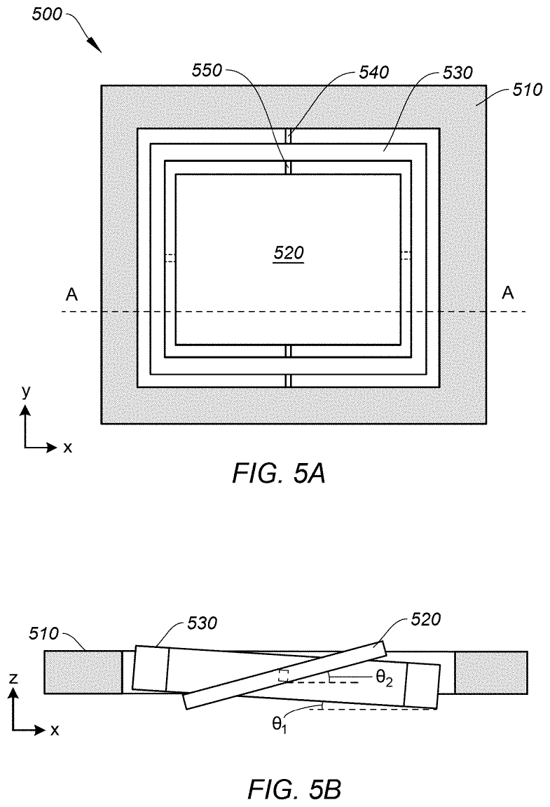

A micro-mirror in a MEMS-based micro-mirror system may be rotated around an actual or virtual pivot or connection point (e.g., a torsional beam or a rotational axis) by an actuator shown in, for example, FIGS. 5A and 5B, such as a micro-motor, an electromagnetic actuator, an electrostatic actuator, or an acoustic actuator. FIG. 6 shows an exemplary embodiment of a piezoelectric driven MEMS-based micro-mirror using novel connection springs 680a-l that can reduce deleterious effects of temperature variation on piezoelectric driven MEMS-based systems. The connection springs can be shaped to accommodate a particular frequency response of the system (e.g., resonant frequency) and to affect the force and torque applied to the mirror, as further described below. FIGS. 8-13 show various implementations using connection springs and piezoelectric actuators with different orientations and configurations. FIG. 14 shows a family of frequency response curves that illustrate performance advantages of using piezoelectric actuators in the manner described herein.

In the following description, for the purposes of explanation, specific details are set forth in order to provide a thorough understanding of examples of the disclosure. It will be apparent that various examples may be practiced without these specific details. The ensuing description provides examples only, and is not intended to limit the scope, applicability, or configuration of the disclosure. Rather, the ensuing description of the examples will provide those skilled in the art with an enabling description for implementing an example. It should be understood that various changes may be made in the function and arrangement of elements without departing from the spirit and scope of the disclosure as set forth in the appended claims. The figures and description are not intended to be restrictive. Circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples. The teachings disclosed herein can also be applied to various types of applications such as mobile applications, non-mobile applications, desktop applications, web applications, enterprise applications, and the like. Further, the teachings of this disclosure are not restricted to a particular operating environment (e.g., operating systems, devices, platforms, and the like) but instead can be applied to multiple different operating environments.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Where components are described as being “configured to” perform certain operations, such configuration may be accomplished, for example, by designing electronic circuits or other hardware to perform the operation, by programming or controlling electronic circuits (e.g., microprocessors, or other suitable electronic circuits) to perform the operation, or any combination thereof.

The word “example” or “exemplary” is used herein to mean “serving as an example, instance, or illustration.” Any embodiment or design described herein as “exemplary” or “example” is not necessarily to be construed as preferred or advantageous over other embodiments or designs.

Light beam steering techniques can be used in many optical systems, such as optical display systems, optical sensing and detecting systems, optical imaging systems, and the like. For example, a LiDAR system is an active remote sensing system that can be used to obtain the range from a transmitter to one or more points on a target in a field of view (FOV). A LiDAR system uses a light beam, typically a laser beam, to illuminate the one or more points on the target. Compared with other light sources, a laser beam may propagate over long distances without spreading significantly (highly collimated), and can be focused to small spots so as to deliver high optical power densities and provide fine resolution. The laser beam may be modulated such that the transmitted laser beam may include a series of pulses. The transmitted laser beam may be directed to a point on the target, which may then reflect or scatter the transmitted laser beam. The laser beam reflected or scattered from the point on the target back to the LiDAR system can be measured, and the time of flight (ToF) from the time a pulse of the transmitted light beam is transmitted from the transmitter to the time the pulse arrives at a receiver near the transmitter or at a known location may be measured. The range from the transmitter to the point on the target may then be determined by, for example, r=c×t/2, where r is the range from the transmitter to the point on the target, c is the speed of light in free space, and t is the ToF of the pulse of the light beam from the transmitter to the receiver.

A LiDAR system may include, for example, a single-point scanning system or a single-pulse flash system. A single-point scanning system may use a scanner to direct a pulsed light beam (e.g., a pulsed laser beam) to a single point in the field of view at a time and measure the reflected or backscattered light beam with a photodetector. The scanner may then slightly tilt the pulsed light beam to illuminate the next point, and the process may be repeated to scan the full field of view. A flash LiDAR system, on the other hand, may transmit a wider-spread light beam and use a photodiode array (e.g., a focal-plane array (FPA)) to measure the reflected or backscattered light at several points simultaneously. Due to the wider beam spread, a flash LiDAR system may scan a field of view faster than a single-point scanning system, but may need a much more powerful light source to simultaneously illuminate a larger area.

A MEMS micro-mirror can be an important component in a LiDAR system. Its performance can directly affect the quality of the point cloud and the corresponding image. To increase the detection range, a large aperture MEMS micro-mirror may be used, which can increase a moment of inertia of the micro-mirror. To achieve a high resolution image, a high resonant frequency of the device is often used. Conventional devices may resort to torsion springs with a high stiffness to achieve a high resonant frequency of the device. A higher stiffness can further require a larger drive force/torque to maintain a pre-determined mirror angle amplitude. Therefore, for large aperture mirrors, a large drive force is typically needed to start and to maintain a large enough angle of mirror oscillation.

FIG. 1 illustrates an example of a vehicle 100 including a LiDAR system 102 according to certain embodiments. LiDAR system 102 may allow vehicle 100 to perform object detection and ranging in the surrounding environment. Based on the result of the object detection and ranging, vehicle 100 may, for example, automatically maneuver (with little or no human intervention) to avoid a collision with an object in the environment. LiDAR system 102 may include a transmitter 104 and a receiver 106. In some embodiments, transmitter 104 and receiver 106 may share at least some optical components. For example, in a coaxial LiDAR system, the outgoing light from transmitter 104 and returned light to receiver 106 may be directed by the same scanning system and may at least partially overlap in space.

Transmitter 104 may direct one or more light pulses 108 (or a frequency modulated continuous wave (FMCW) light signal, an amplitude modulated continuous wave (AMCW) light signal, etc.), at various directions at different times according to a suitable scanning pattern. Receiver 106 may detect returned light pulses 110, which may be portions of transmitted light pulses 108 that are reflected or scattered by one or more areas on one or more objects. LiDAR system 102 may detect the object based on the detected light pulses 110, and may also determine a range (e.g., a distance) of each area on the detected objects based on a time difference between the transmission of a light pulse 108 and the reception of a corresponding light pulse 110, which is referred to as the time of flight. Each area on a detected object may be represented by a data point that is associated with a two-dimensional (2-D) or three-dimensional (3-D) direction and distance with respect to LiDAR system 102.

The above-described operations can be repeated rapidly for many different directions. For example, the light pulses can be scanned using various scanning mechanisms (e.g., spinning mirrors or MEMS devices) according to a one-dimensional or two-dimensional scan pattern for two-dimensional or three-dimensional detection and ranging. The collection of the data points in the 2-D or 3-D space may form a “point cloud,” which may indicate, for example, the direction, distance, shape, and dimensions of a detected object relative to the LiDAR system.

In the example shown in FIG. 1, LiDAR system 102 may transmit light pulse 108 towards a field in front of vehicle 100 at time t₁, and may receive, at time t₂, a returned light pulse 110 that is reflected by an object 112 (e.g., another vehicle). Based on the detection of light pulse 110, LiDAR system 102 may determine that object 112 is in front of vehicle 100. In addition, based on the time difference between t₁ and t₂ (not shown), LiDAR system 102 may determine a distance 114 between vehicle 100 and object 112. LiDAR system 102 may also determine other useful information, such as a relative speed and/or acceleration between two vehicles and/or the dimensions of the detected object (e.g., the width or height of the object), based on additional light pulses detected. As such, vehicle 100 may be able to adjust its speed (e.g., slowing down, accelerating, or stopping) to avoid collision with other objects, or may be able to control other systems (e.g., adaptive cruise control, emergency brake assist, anti-lock braking systems, or the like) based on the detection and ranging of objects by LiDAR system 102.

LiDAR systems may detect objects at distances ranging from a few meters to more than 200 meters. Because of its ability to collimate laser light and its short wavelength (e.g., about 905 nm to about 1,550 nm), LiDAR using infrared (IR) light may achieve a better spatial or angular resolution (e.g., on the order of 0.1°) for both azimuth and elevation than radars, thereby enabling better object classification. This may allow for high-resolution 3D characterization of objects in a scene without significant backend processing. In contrast, radars using longer wavelengths, for example, about 4 mm for about 77 GHz signals, may not be able to resolve small features, especially as the distance increases. LiDAR systems may also have large horizontal (azimuth) FOVs, and better vertical (elevation) FOVs than radars. LiDAR systems can have very high performance at night. LiDAR systems using modulated LiDAR techniques may be robust against interference from other sensors.

The strength or signal level of the returned light pulses may be affected by many factors, including, but not limited to, the transmitted light signal strength, the light incident angle on an object, the object reflection or scattering characteristics, the attenuation by the propagation medium, the system front end gain or loss, the loss caused by optical components in LiDAR system 102, and the like. The noise floor may be affected by, for example, the ambient light level and front end gain settings. Generally, in a LiDAR system, the signal-to-noise ratio (SNR) of the measured signal for middle and long ranges may decrease with the increase in the distance of detection. For objects in a certain short or middle range (e.g., about 20 m), the signal levels of the returned light pulses may be much higher compared with the ambient noise level, and thus the SNR of the detection signal of the photodetector can be relatively high. On the other hand, light pulse signals returned from long ranges (e.g., about 200 m) may be significantly weaker and may have signal strength levels similar to the ambient noise level and thus a low SNR, or may not even be detected by some low sensitivity photodetectors. In addition, some LiDAR systems may have difficulty detecting objects at close distances because the time of flight is short and the LiDAR optics may be configured for middle to long range detection. For example, without a more complex assembly, one set of lenses may not be good for both short distances (e.g., <1 m) and long distances (e.g., >40 m).

Thus, even though not shown in FIG. 1, in some embodiments, vehicle 100 may include other sensors at various locations, such as, for example, cameras, ultrasonic sensors, radar sensors (e.g., short- and long-range radars), a motion sensor or an inertial measurement unit (IMU, e.g., an accelerometer and/or a gyroscope), a wheel sensor (e.g., a steering angle sensor or rotation sensor), a GNSS receiver (e.g., a GPS receiver), and the like. Each of these sensors may generate signals that provide information relating to vehicle 100 and/or the surrounding environment. Each of the sensors may send and/or receive signals (e.g., signals broadcast into the surrounding environment and signals returned from the ambient environment) that can be processed to determine attributes of features (e.g., objects) in the surrounding environment. LiDARs, radars, ultrasonic sensors, and cameras each have their own advantages and disadvantages. Highly or fully autonomous vehicles typically use multiple sensors to create an accurate long-range and short-range map of a vehicle's surrounding environment, for example, using sensor fusion techniques. In addition, it is also desirable to have sufficient overlap of coverage by the different sensors in order to increase redundancy and improve safety and reliability.

The cameras may be used to provide visual information relating to vehicle 100 and/or its surroundings, for example, for parking assistance, traffic sign recognition, pedestrian detection, lane markings detection and lane departure warning, surround view, and the like. The cameras may include a wide-angle lens, such as a fisheye lens that can provide a large (e.g., larger than 150°) angle of view. Multiple cameras may provide multiple views that can be stitched together to form an aggregated view. For example, images from cameras located at each side of vehicle 100 can be stitched together to form a 360° view of the vehicle and/or its surrounding environment. Cameras are cost-efficient, easily available, and can provide color information. However, cameras may depend strongly on the ambient light conditions, and significant processing may need to be performed on the captured images to extract useful information.

In some embodiments, vehicle 100 may include ultrasonic sensors on the front bumper, the driver side, the passenger side, and/or the rear bumper of vehicle 100. The ultrasonic sensors may emit ultrasonic waves that can be used by the vehicle control system to detect objects (e.g., people, structures, and/or other vehicles) in the surrounding environment. In some embodiments, the vehicle control system may also use the ultrasonic waves to determine speeds, positions (including distances), and/or other attributes of the objects relative to vehicle 100. The ultrasonic sensors may also be used, for example, for parking assistance. Ultrasonic waves may suffer from strong attenuation in air beyond a few meters. Therefore, ultrasonic sensors are primarily used for short-range object detection.

An IMU may measure the speed, linear acceleration or deceleration, angular acceleration or deceleration, or other parameters related to the motion of vehicle 100. A wheel sensor may include, for example, a steering angle sensor that measures the steering wheel position angle and rate of turn, a rotary speed sensor that measures wheel rotation speed, or another wheel speed sensor.

Radar sensors may emit radio frequency waves that can be used by the vehicle control system to detect objects (e.g., people, structures, and/or other vehicles) in the surrounding environment. In some embodiments, the vehicle control system may use the radio frequency waves to determine speeds, positions (including distances), and/or other attributes of the objects. The radar sensors may include long-range radars, medium-range radars, and/or short-range radars, and may be used, for example, for blind spot detection, rear collision warning, cross-traffic alert, adaptive cruise control, and the like.

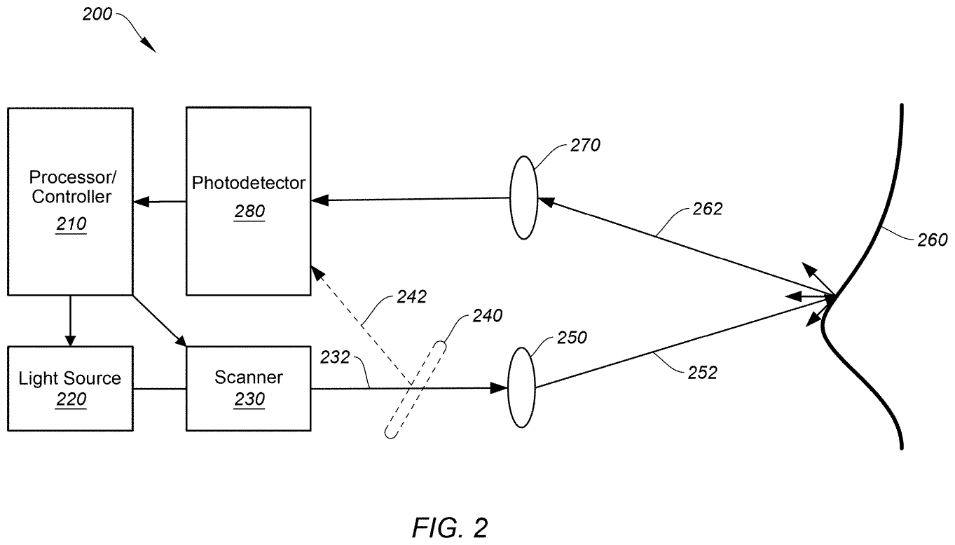

FIG. 2 is a simplified block diagram of an example of a LiDAR system 200 according to certain embodiments. LiDAR system 200 may include a transmitter that may include a processor/controller 210, a light source 220, a scanner 230 for scanning an output light beam from light source 220, and a transmitter lens 250. Light source 220 may include, for example, a laser, a laser diode, a vertical cavity surface-emitting laser (VCSEL), a light-emitting diode (LED), or other optical sources. The laser may include, for example, an infrared pulsed fiber laser or other mode-locked laser with an output wavelength of, for example, 930-960 nm, 1030-1070 nm, around 1550 nm, or longer. Processor/controller 210 may control light source 220 to transmit light pulses. Scanner 230 may include, for example, a rotating platform driven by a motor, a multi-dimensional mechanical stage, a Galvo-controlled mirror, a MEMS mirror driven by micro-motors, a piezoelectric translator/transducer using a piezoelectric material such as a quartz or lead zirconate titanate (PZT) ceramic, an electromagnetic actuator, a resonant fiber scanner, or an acoustic actuator. In one example, LiDAR system 200 may include a single-point scanning system that uses a MEMS combined with a mirror to reflect a pulsed light beam to a single point in the field of view. In some embodiments, scanner 230 may not include a mechanically moving component, and may use, for example, a phased array technique where phases of an array of light beams (e.g., from lasers in a one-dimensional (1-D or 2-D laser array) may be modulated to alter the wave front of the superimposed light beam. Transmitter lens 250 may direct a light beam 232 towards a target 260 as shown by light beam 252.

LiDAR system 200 may include a receiver that may include a receiver lens 270, a photodetector 280, and processor/controller 210. Reflected or scattered light beam 262 from target 260 may be collected by receiver lens 270 and directed to photodetector 280. Photodetector 280 may include a detector having a working (sensitive) wavelength comparable with the wavelength of light source 220. Photodetector 280 may be a high speed photodetector, such as a PIN photodiode with an intrinsic region between a p-type semiconductor region and an n-type semiconductor region, a silicon photomultiplier (SiPM) sensor, an avalanche photodetector (APD), and the like. Processor/controller 210 may be used to synchronize and control the operations of light source 220, scanner 230, and photodetector 280, and analyze measurement results based on the control signals for light source 220 and scanner 230, and the signals detected by photodetector 280.

In some embodiments, a beam splitter 240 may split light beam 232 from scanner 230 and direct a portion of light beam 232 towards photodetector 280 as shown by light beam 242 in FIG. 2. Light beam 242 may be directed to photodetector 280 by beam splitter 240 directly or indirectly through one or more mirrors. In some embodiments, the light beam from the light source may be split and directed to the receiver before entering scanner 230. By partially directing the transmitted pulses near the transmission source to photodetector 280, the pulses captured by photodetector 280 immediately after transmission can be used as the transmitted pulses or reference pulses for determining the time of flight. To measure the time of flight, approximate positions of transmitted and returned pulses must be identified within the waveform of the detection signal of photodetector 280. A LiDAR system may use, for example, a leading-edge detector, a peak detector, or a matched-filter detector, to recover transmitted and/or returned light pulses in the detection signal from the photodetector.

In the example illustrated in FIG. 2, LiDAR system 200 may be a non-coaxial LiDAR system, where the receiver and the transmitter may use different optical components, and the outgoing light and the returned light may not spatially overlap. In some embodiments, the LiDAR systems may be coaxial systems, where, for example, the outgoing light and the returned light may be scanned by a same scanner and may at least spatially overlap at the scanner.

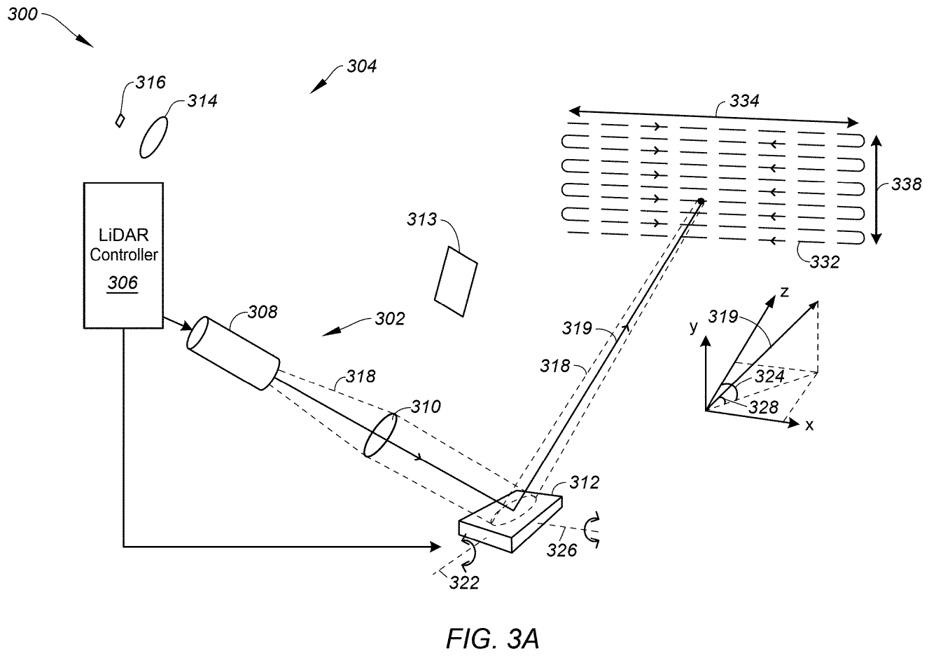

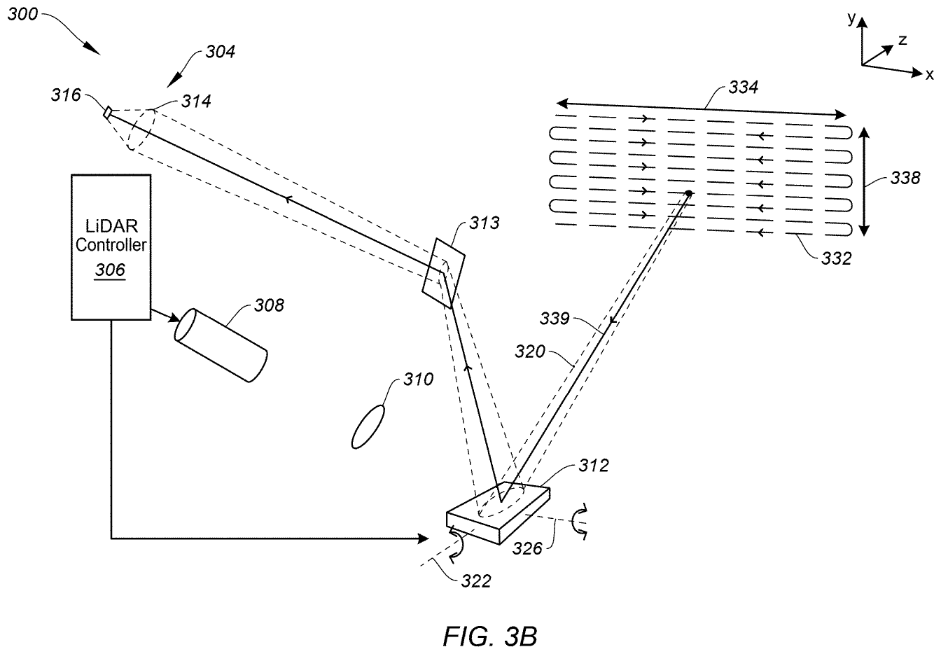

FIG. 3A and FIG. 3B show a simplified block diagram of an example of a LiDAR module 300 according to certain embodiments. LiDAR module 300 may be an example of LiDAR system 102, and may include a transmitter 302, a receiver 304, and a LiDAR controller 306 that controls the operations of transmitter 302 and receiver 304. Transmitter 302 may include a light source 308 and a collimator lens 310. Receiver 304 may include a lens 314 and a photodetector 316. LiDAR module 300 may further include a mirror assembly 312 and a beam deflector 313. In some embodiments, transmitter 302 and receiver 304 may be configured to share mirror assembly 312 (e.g., using a beam splitter/combiner) to perform a light steering and detecting operation, with beam deflector 313 configured to reflect incident light reflected by mirror assembly 312 to receiver 304. In some embodiments, beam deflector 313 may also be shared by transmitter 302 and receiver 304 (e.g., via a beam splitter/combiner), where outgoing light from light source 308 and reflected by mirror assembly 312 may also be reflected by beam deflector 313, while the returned beam may be deflected by mirror assembly 312 and beam deflector 313 to lens 314 and photodetector 316.

FIG. 3A shows an example of a beam steering operation by LiDAR module 300. To project light, LiDAR controller 306 can control light source 308 to transmit a light beam 318 (e.g., light pulses, an FMCW light signal, an AMCW light signal, etc.). Light beam 318 may diverge upon leaving light source 308 and may be collimated by collimator lens 310. The collimated light beam 318 may propagate with substantially the same beam size.

The collimated light beam 318 may be incident upon mirror assembly 312, which can reflect and steer the light beam along an output projection path 319 towards a field of interest, such as object 112. Mirror assembly 312 may include one or more rotatable mirrors, such as a one-dimensional or two-dimensional array of micro-mirrors. Mirror assembly 312 may also include one or more actuators (not shown in FIG. 3A) to rotate the rotatable mirrors. The actuators may rotate the rotatable mirrors around a first axis 322, and/or may rotate the rotatable mirrors around a second axis 326. The rotation around first axis 322 may change a first angle 324 (e.g., longitude angle) of output projection path 319 with respect to a first dimension (e.g., the x-axis or z-axis). The rotation around second axis 326 may change a second angle 328 (e.g., altitude angle) of output projection path 319 with respect to a second dimension (e.g., the y-axis). LiDAR controller 306 may control the actuators to produce different combinations of angles of rotation around first axis 322 and second axis 326 such that the movement of output projection path 319 can follow a scanning pattern 332. A range 334 of movement of output projection path 319 along the x-axis, as well as a range 338 of movement of output projection path 319 along the y-axis, can define a FOV. An object within the FOV, such as object 112, can receive and scatter the collimated light beam 318 to form returned light signals, which can be received by receiver 304.

FIG. 3B shows an example of a returned beam detection operation by LiDAR module 300. LiDAR controller 306 can select an incident light direction 339 for detection of incident light by receiver 304. The selection can be based on setting the angles of rotation of the rotatable mirrors of mirror assembly 312, such that only light beam 320 propagating along incident light direction 339 is reflected to beam deflector 313, which can then divert light beam 320 to photodetector 316 via lens 314. Photodetector 316 may include any suitable high-speed detector that can detect light pulses in the working wavelength of the LiDAR system, such as a PIN photodiode, a silicon photomultiplier (SiPM) sensor, or an avalanche photodetector. With such arrangements, receiver 304 can selectively receive signals that are relevant for the ranging/imaging of a target object, such as light pulse 110 generated by the reflection of the collimated light beam by object 112, and not to receive other signals. As a result, the effect of environment disturbance on the ranging/imaging of the object can be reduced, and the system performance can be improved.

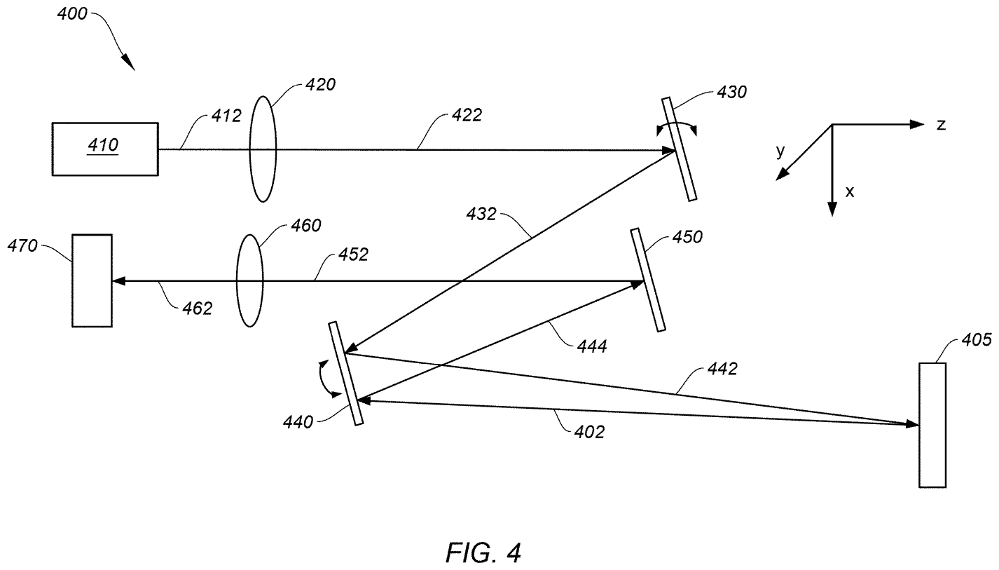

FIG. 4 is a simplified block diagram of an example of an optical subsystem 400 in a LiDAR system, such as LiDAR system 102 shown in FIG. 1, according to certain embodiments. In some embodiments, a plurality of optical subsystems 400 can be integrated into the LiDAR system to achieve, for example, 360° coverage in the transverse plane. In one example, a LiDAR system may include eight optical subsystems 400 distributed around a circle, where each optical subsystem 400 may have a field of view about 45° in the transverse plane.

In the example shown in FIG. 4, optical subsystem 400 may include a light source 410, such as a laser (e.g., a pulsed laser diode). A light beam 412 emitted by light source 410 may be collimated by a collimation lens 420. The collimated light beam 422 may be incident on a first deflector 430, which may be stationary or may rotate in at least one dimension such that collimated light beam 422 may at least be deflected by first deflector 430 towards, for example, different y locations. Collimated light beam 432 deflected by first deflector 430 may be further deflected by a second deflector 440, which may be stationary or may rotate in at least one dimension. For example, second deflector 440 may rotate and deflect collimated light beam 432 towards different x locations. Collimated light beam 442 deflected by second deflector 440 may reach a target point at a desired (x, y) location on a target object 405. As such, first deflector 430 and second deflector 440 may, alone or in combination, scan the collimated light beam in two dimensions to different (x, y) locations in a far field.

Target object 405 may reflect collimated light beam 442 by specular reflection or scattering. At least a portion of the reflected light 402 may reach second deflector 440 and may be deflected by second deflector 440 as a light beam 444 towards a third deflector 450. Third deflector 450 may deflect light beam 444 as a light beam 452 towards a receiver, which may include a lens 460 and a photodetector 470. Lens 460 may focus light beam 452 as a light beam 462 onto a location on photodetector 470, which may include a single photodetector or an array of photodetectors. Photodetector 470 may be any suitable high-speed detector that can detect light pulses in the working wavelength of the LiDAR system, such as a PIN photodiode, an SiPM sensor, or an avalanche photodetector. In some embodiments, one or more other deflectors may be used in the optical path to change the propagation direction of the light beam (e.g., fold the light beam) such that the size of optical subsystem 400 may be reduced or minimized without impacting the performance of the LiDAR system. For example, in some embodiments, a fourth deflector may be placed between third deflector 450 and lens 460, such that lens 460 and photodetector 470 may be placed in desired locations in optical subsystem 400.

The light deflectors described above may be implemented using, for example, a micro-mirror array, a Galvo mirror, a stationary mirror, a grating, or the like. In one example, first deflector 430 may include a micro-mirror array, second deflector 440 may include a Galvo mirror, and third deflector 450 and other deflectors may include stationary mirrors. A micro-mirror array can have an array of micro-mirror assemblies, with each micro-mirror assembly having a rotatable micro-mirror and an actuator (or multiple actuators). The micro-mirrors and actuators can be formed as a MEMS on a semiconductor substrate, which may allow the integration of the MEMS with other circuitries (e.g., controller, interface circuits, etc.) on the semiconductor substrate.

In some MEMS micro-mirrors, a rotatable mirror may be supported by, for example, one or more torsional beams or springs (e.g., typically referred to herein as “torsion springs”), which may in turn be anchored to a substrate. In some embodiments, the rotatable mirror may be supported by an accompanying gimbal that may in turn be supported by one or more torsional beams or springs. The rotatable mirror and/or the gimbal may be rotated around an actual or virtual pivot or connection point (e.g., the torsional beams or an axis of rotation) by an actuator, such as a micro-motor, an electromagnetic actuator, an electrostatic actuator, an acoustic actuator, or a piezoelectric actuator including a piezoelectric material, such as quartz or lead zirconate titanate (PZT) ceramic. Some MEMS micro-mirrors may not include torsional beams or springs, where a micro-mirror may be attached to two or more actuators that may be anchored to the substrate and hold the micro-mirror in place. The various embodiments further discussed below employ piezoelectric actuators and novel connection springs that couple the piezoelectric actuators to the MEMS mirror structure. A “mirror structure” is an umbrella term that can mean a MEMS mirror device that does or does not also include a gimbal structure, according to certain embodiments.

FIG. 5A shows an example of a rotatable micro-mirror assembly 500, according to certain embodiments. Rotatable micro-mirror assembly 500 may be a micro-mirror element in an array of micro-mirror elements fabricated on a wafer. Rotatable micro-mirror assembly 500 may include a substrate 510, a micro-mirror 520, and a gimbal 530 (also referred to as a “frame” or a “gimbal frame”). In some implementations, gimbal 530 may not be used, and micro-mirror 520 may be directly connected to substrate 510. Substrate 510 may include a semiconductor substrate, such as a silicon wafer. In some implementations, a silicon oxide or silicon nitride layer may be formed on the silicon wafer. In some implementations, electrodes and other circuits and/or structures may be formed on substrate 510. For example, piezoelectric actuators, electromagnetic actuators, electrostatic actuators, or other electrically controllable actuators may be formed on substrate 510. Some examples of actuators are described in more detail with respect to other figures below. In some aspects, the actuators (e.g., piezoelectric actuators), the mirror, the gimbal, the connective structures, connection springs, torsion springs, anchors, etc., may all be formed on the same semiconductor substrate to form a common integrated circuit, as would be appreciated by one of ordinary skill in the art with the benefit of this disclosure.

Gimbal 530 may be etched or otherwise formed on substrate 510, and may include a ring having a desired shape, such as a rectangular, circular, or oval shape. Micro-mirror 520 may also be etched or otherwise formed on substrate 510. Micro-mirror 520 may have a rectangular, circular, or oval shape and may include a highly reflective surface. Gimbal 530 and micro-mirror 520 may form a mirror structure (also referred to as a “gimbal structure”). For example, two or more connectors 550 may connect micro-mirror 520 to gimbal 530, while two or more connectors 540 may connect gimbal 530 (and micro-mirror 520) to substrate 510. Connectors 550 and 540 may be torsional structures (e.g., torsion springs) formed (e.g., etched) on substrate 510, and may be elastic and deformable. The torsional structures can be in the form of, for example, a torsional beam, bar, spring, and the like. The torsional structures may have a certain stiffness, and may provide the restoring force for returning micro-mirror 520 and/or gimbal 530 to their original positions. Connectors 550 and 540 may also function as pivotal points or pivotal connections, around which gimbal 530 and micro-mirror 520 may rotate. For example, a pair of connectors 550 may form a pivot/axis of rotation of micro-mirror 520 around the y-axis within frame 530, while another pair of connectors 550 may form a pivot/axis of rotation of micro-mirror 520 around the x-axis within gimbal 530. A pair of connectors 540 may function as a pivot/axis of rotation of gimbal 530 and micro-mirror 520 around the y-axis with respect to substrate 510.

Rotatable micro-mirror assembly 500 may be used to deflect an incident light beam, such as a collimated infrared laser beam, to a desired direction in a two-dimensional or three-dimensional space. For example, micro-mirror 520 may be rotated by a desired angle around the x and/or y-axis to direct the incident light to a desired direction. Micro-mirror 520 may be continuously rotated or may be rotated in a number of steps to perform a two-dimensional or three-dimensional scan. The range of the rotation angles of micro-mirror 520 may define the field of view of micro-mirror 520.

FIG. 5B includes a cross-sectional view (e.g., along a line A-A) of the example of rotatable micro-mirror assembly 500 shown in FIG. 5A according to certain embodiments. In the example shown in FIG. 5B, gimbal 530 may be rotated by an angle θ₁ around the y-axis (e.g., an axis formed by a pair of connectors 540) within substrate 510 and with respect to substrate 510, while micro-mirror 520 may be rotated by an angle θ₂ around the y-axis (e.g., an axis formed by a pair of connectors 550) within gimbal 530 and with respect to substrate 510.

The rotation angle (e.g., θ₁ or θ₂) may depend on the torque τ applied to gimbal 530 or micro-mirror 520 and the stiffness K of connectors 540 or 550 according to:

τ=−Kθ.

The stiffness K of the connectors may be affected by several factors, such as the material of the connectors, the cross-sectional area of the connectors, the shape of the connectors, and the like. In one example, the stiffness K can be determined according to:

$$K = \frac{{k}_{2} \times G \times {w}^{3} \times H}{L} ,$$

where L is the length of a connector, G is the shear modulus of the material that forms the connector, and k₂ is a factor that depends on the ratio between the thickness (H) and the width (w) of the connector.

Different rotation angles of the micro-mirror may be achieved by applying different torques to gimbal 530 or micro-mirror 520 by an actuator. When the torque from the actuator is removed or reduced, the torsional force caused by the distortion (e.g., bend or twist) and the elasticity of the connectors may return micro-mirror 520 or gimbal 530 back to its default position. Micro-mirror 520 or gimbal 530 may be driven again to start another rotation. The rotations of micro-mirror 520 or gimbal 530 may be in the form of an oscillation. In a steady state, micro-mirror 520 may rotate at a resonant frequency co that may depend on the stiffness K of the connectors and the moment of inertia J of micro-mirror 520 according to:

$$ω = \sqrt{\frac{K}{J}} .$$

The actuator may apply and then remove a torque at the resonant frequency of micro-mirror 520 to maintain the oscillation. For example, during the steady state, the actuator may apply a torque at the resonant frequency to overcome the damping of the oscillation caused by, for example, frictions or other sources that may cause the conversion of kinetic energy to thermal energy.

According to certain embodiments, piezoelectric actuators may be used in rotatable micro-mirror assemblies to achieve the large displacements and large rotation angles. The piezoelectric actuators may physically connect the micro-mirrors and/or gimbals to fixation points and thus may not have the disengagement issue associated with electrostatic actuators. In addition, the piezoelectric actuators can be used as torsional structures such that additional torsional structures (e.g., connectors 540) may or may not be used. The piezoelectric actuators can be designed to provide a large displacement and have a sufficiently high stiffness.

FIG. 6A shows an example of a rotatable micro-mirror assembly 600 including piezoelectric actuators 610 and 614 according to certain embodiments. Rotatable micro-mirror assembly 600 may be an example of rotatable micro-mirror assembly 500, and may include a gimbal frame 620 and a micro-mirror 630. Piezoelectric actuators 610 and 614 may each be fixed to an anchor 612 or 616, which may be a substrate or may be formed on a substrate. Piezoelectric actuators 610 and 614 may each be connected to gimbal frame 620 through one or more connection structures 640. In some embodiments, each connection structure 640 may include a structure 642 that may be deformed to extend when the displacement is large and the tension force is large.

In some embodiments, gimbal frame 620 may be connected to a pair of anchors 650 through torsion beams 622. Anchors 650 may be pivotal points around which gimbal frame 620 may rotate. In some embodiments, anchors 650 and torsional beams 622 may not be used and gimbal frame 620 may rotate round an axis 652 due to the symmetrical structure of piezoelectric actuators 610 and 614 on opposite sides. Micro-mirror 630 may be connected to gimbal frame 620 through two or more connectors 625, such as torsional beams or springs.

Piezoelectric actuators 610 and 614 may each be controlled by an electrical signal (e.g., an AC signal, such as a square wave or a sinusoidal wave) to bend upward or downward, such that the movable ends of piezoelectric actuators 610 and 614 may oscillate up and down. During operations of rotatable micro-mirror assembly 600, piezoelectric actuators 610 and 614 may be controlled by electrical signals to bend in opposite directions, such as +z and −z directions. Piezoelectric actuators 610 and 614, when bended, may pull gimbal frame 620 from opposite sides and in opposite directions through connection structures 640, and thus may rotate gimbal frame 620 and micro-mirror 630 around axis 652.

FIG. 6B shows an example of an operating condition of the example of rotatable micro-mirror assembly 600 shown in FIG. 6A. In the illustrated example, piezoelectric actuator 610 may bend downward, while piezoelectric actuator 614 may bend upward. For example, the movable end of piezoelectric actuator 614 may have a vertical displacement Z, whereas the movable end of piezoelectric actuator 610 may have a vertical displacement −Z. Thus, one side of gimbal frame 620 may be pulled up and an opposite side of gimbal frame 620 may be pulled down to rotate gimbal frame 620 clockwise by an angle θ, which may cause micro-mirror 630 to rotate as well due to the connectors 625 between gimbal frame 620 and micro-mirror 630. Because the piezoelectric actuators are bended and gimbal frame 620 is rotated, the distance between gimbal frame 620 and each piezoelectric actuator may be increased as shown in FIG. 6B. Connection structures 640, more specifically, structures 642, may be deformed to extend, such that gimbal frame 620 is still connected to piezoelectric actuators 610 and 614 through connection structures 640.

In some embodiments, at a given time, one of piezoelectric actuators 610 and 614 may be driven by a control signal, while the other one of piezoelectric actuators 610 and 614 may not be driven by a control signal. When driven by the control signals, piezoelectric actuators 610 and 614 may bend in the same direction. For example, during a first half period of an oscillation period, only piezoelectric actuator 614 may be driven by a control signal to bend upward, thereby causing micro-mirror 630 to rotate, for example, clockwise; during the second half period of the oscillation period, only piezoelectric actuator 610 may be driven by a control signal to bend upward, thereby causing micro-mirror 630 to rotate counter-clockwise.

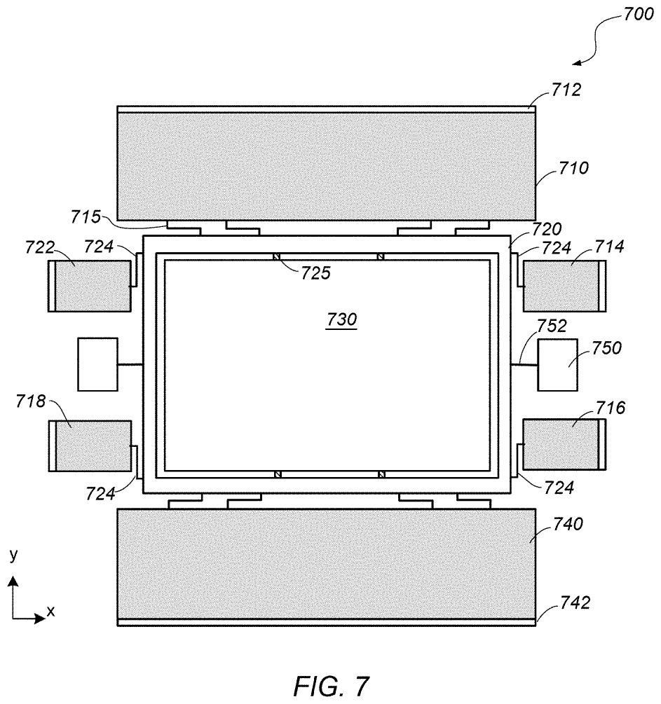

FIG. 7 shows another example of a rotatable micro-mirror assembly 700 including piezoelectric actuators, according to certain embodiments. Rotatable micro-mirror assembly 700 may be another example of rotatable micro-mirror assembly 500. Rotatable micro-mirror assembly 700 may include a pair of piezoelectric actuators 710 and 740, which may be attached to anchors 712 and 742, respectively. A gimbal frame 720 may be connected to piezoelectric actuators 710 and 740 by a set of novel connection springs 715, such as two or more connection springs 715, four or more connection springs 715, six or more connection springs 715, eight or more connection springs 715, or the like. In some embodiments, gimbal frame 720 may also be connected to a pair of anchors 750 by a pair of torsional beams 752. A micro-mirror 730 may be connected to gimbal frame 720 by a set of connection structures 725 (e.g., elastic connectors). In some embodiments, alternative or additional piezoelectric actuators 714, 716, 718, and/or 722 and novel connection springs 724 may be used to rotate gimbal frame 720 and micro-mirror 730.

Piezoelectric actuators 710 and 740 may each be controlled by an electrical signal (e.g., an AC signal) to bend upward or downward, such that the movable ends of piezoelectric actuators 710 and 740 may oscillate up and down. During operations of rotatable micro-mirror assembly 700, piezoelectric actuators 710 and 740 may be controlled by electrical signals to bend in opposite directions. Piezoelectric actuators 710 and 740, when bended, may pull gimbal frame 720 from opposite sides and in opposite directions through connection springs 715, and thus may rotate gimbal frame 720 and micro-mirror 730 around anchors 750.

Piezoelectric actuators 714, 716, 718, and 722, when present, may work together with piezoelectric actuators 710 and 740 to provide a larger torque. For example, piezoelectric actuators 714 and 722 may be synchronized with piezoelectric actuator 710 such that they may oscillate (bend) in the same direction and at about the same phase with piezoelectric actuator 710 to increase the force and torque applied to gimbal frame 720. Similarly, piezoelectric actuators 716 and 718 may be synchronized with piezoelectric actuator 740 such that they may oscillate (bend) in the same direction and at about the same phase with piezoelectric actuator 740 to increase the force and torque applied to gimbal frame 720.

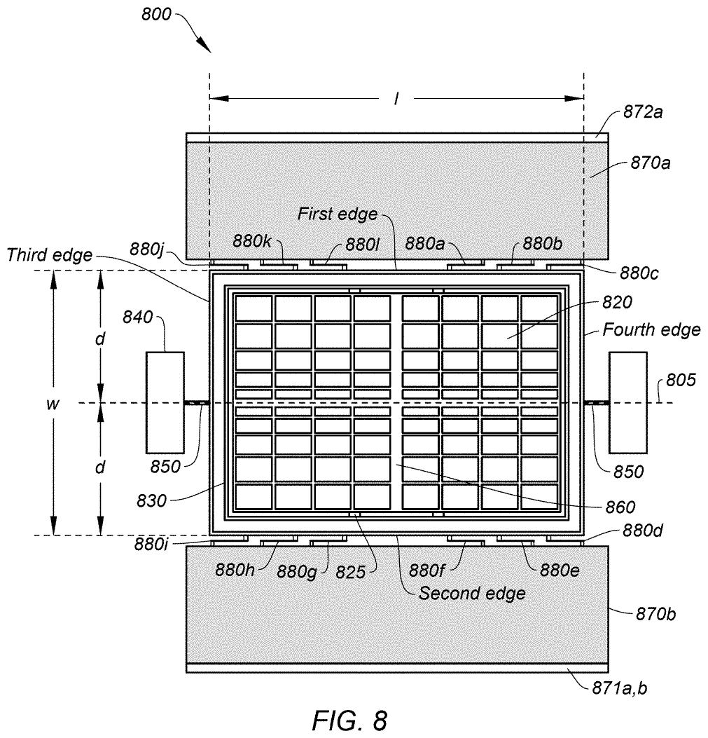

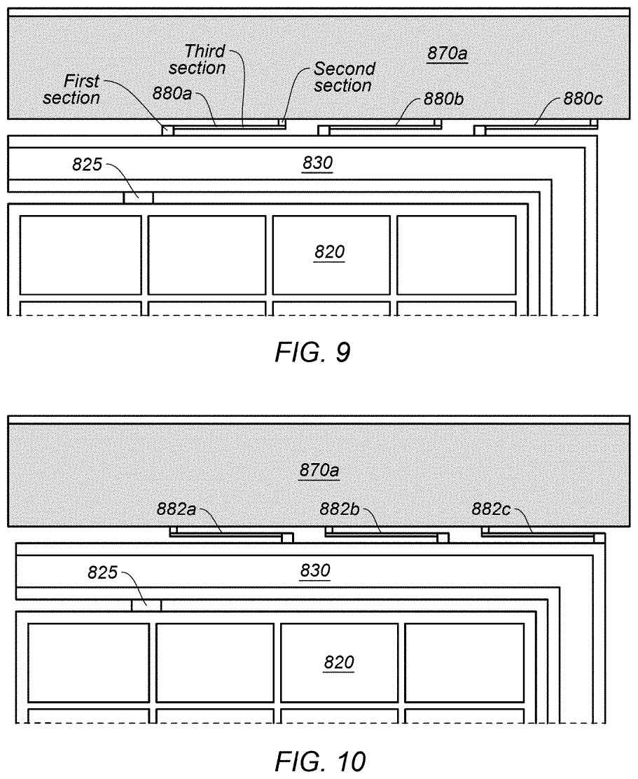

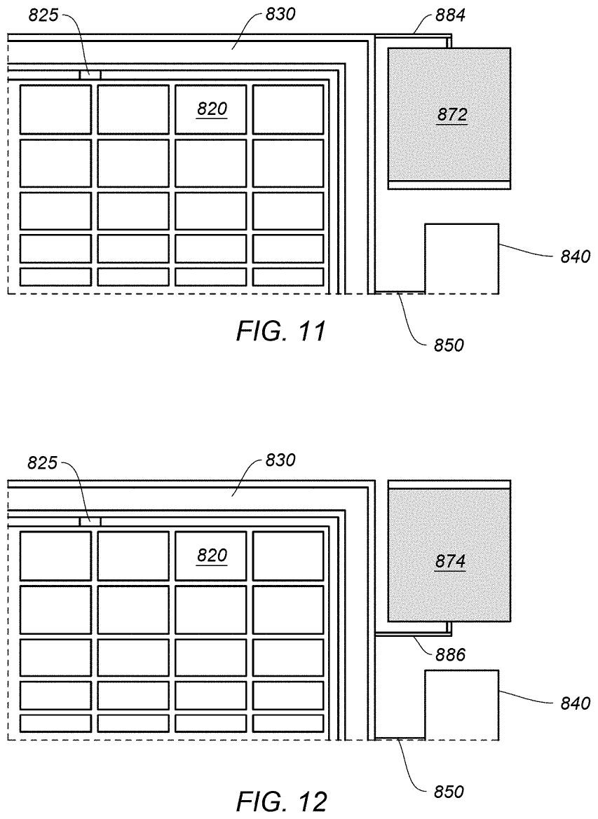

FIG. 8 shows a simplified plan view of a MEMS-based rotatable mirror structure with piezoelectric actuators and a backside skeleton support structure, according to certain embodiments. Micro-mirror assembly 800 may include a pair of piezoelectric actuators 870a and 870b, which may be attached to substrate anchors 872a and 872b, respectively. A gimbal frame 830 may be connected to piezoelectric actuators 870a and 870b by a set of novel connection springs 880a-1. Any number of connection springs 880 may be used. In some embodiments, gimbal frame 830 may also be connected to a pair of anchors 840 by a pair of torsion springs (torsion beam) 850. A mirror 820 may be connected to gimbal frame 830 by a set of connection structures 825 (see FIG. 9). In some embodiments, alternative or additional piezoelectric actuators and novel connection springs may be used to rotate gimbal frame 830 and micro-mirror 820, as shown and described in FIGS. 6 and 11. Piezoelectric actuators 870a, b, can be said to be configured on the “horizontal” sides of the mirror structure.

A backside skeleton support structure 860 can be coupled to a backside of mirror 820 (note that the reflective side of mirror 820 is facing the opposite direction). Although a gimbal structure can be configured between the micro-mirror and torsion bar to help keep the mirror flat during oscillation, large aperture micro-mirror assemblies can still be susceptible to dynamic deformation. To help mitigate dynamic deformation, a thicker mirror can be implemented to increase its stiffness, but can result in an increased mass and corresponding increase in the rotational moment of inertia (due to the larger rotational spring constant to keep its natural frequency at a constant level). To address this problem and take advantage of the stiffness of a thicker mirror, certain implementations of the invention include a dual layered structure including a MEMS-based mirror structure with a hollowed skeleton structure configured on the back to provide improved mechanical support. The backside skeleton structure (also referred to as a “support structure,” “skeleton support structure,” “back support” structure, “backside skeleton,” or “backside structure”) can operate to increase the stiffness of the mirror with a relatively small increase in mass, which can both reduce the moment of inertia of the rotating mirror and reduce dynamic deformation. In the embodiments shown, an array of structural beams forms a matrix of cells. The structural beams provide greater stiffness, and the voids in-between (e.g., the cells) provide a reduced overall mass and moment of inertia of the support structure. Backside skeleton support structures are described in further detail in U.S. patent application Ser. No. 16/905,489, filed on Jun. 18, 2020, which is herein incorporated by reference in its entirety into this application for all purposes.

Piezoelectric actuators 870a and 870b may each be controlled by an electrical signal (e.g., an AC signal) to bend upward or downward, such that the movable ends of piezoelectric actuators 870a and 870b may oscillate up and down. During operation of rotatable micro-mirror assembly 800, piezoelectric actuators 870a and 870b may be controlled by electrical signals to bend in opposite directions. Piezoelectric actuators 870a and 870b, when bended (in response to an applied voltage), may pull gimbal frame 830 from opposite sides and in opposite directions through connection springs 880a-1, and thus may rotate gimbal frame 830 and micro-mirror 820 around anchors 840, as shown and described above with respect to FIG. 6B. As noted above, piezoelectric drives typically require a lower operating voltage than electrostatic drives and can provide a substantially larger drive force, but may be susceptible to temperature variation. The novel connection springs mitigate the issues associated with temperature variation, as described above.

Connection springs 880a-1 can be formed in a number of different shapes, including L-shapes and backwards S-shapes, as depicted more closely and described in FIGS. 9-13 below. The connection spring can be a single beam joining the gimbal at one end and joining the piezoelectric electrode at the other end. The torsion spring could also be a set of more than one connection spring. The connection spring length and width can be determined based on the requirement of a natural frequency of the total system. These connection spring dimensions and the total number of springs can also be adjusted to minimize the dynamic deformation of the mirror. For example, fewer springs may be needed for wider and shorter springs. Also, for a given set of springs, the spring locations can be adjusted to further minimize the dynamic deformation while keeping the natural frequency constant, as would be appreciated by one of ordinary skill in the art with the benefit of this disclosure.

In some exemplary embodiments, a MEMS-based semiconductor integrated circuit for a LiDAR system (the “system 800”) can include a substrate, a first piezoelectric actuator (e.g., 870a) coupled to the substrate, a second piezoelectric actuator (e.g., 870b) coupled to the substrate, and a mirror structure (e.g., 820) configured between the first piezoelectric actuator and the second piezoelectric actuator. The mirror structure can be planar, having a length and a width, and including: a first edge defining the length (1) of the mirror structure, where the first edge is coupled to the first piezoelectric actuator (e.g., 870a) via a first set of connection springs (e.g., 880j-1 and 880a-c), a second edge defining the length of the mirror structure and opposing the first edge, where the second edge is coupled to the second piezoelectric actuator (e.g., 870b) via a second set of connection springs (e.g., 880d-i), a third edge defining the width (w) of the mirror structure, and a fourth edge defining the width of the mirror structure and opposing the third edge. Note that the first-fourth edges are identified as such for reference purposes only to help describe and claim the various aspects of the present invention and one of ordinary skill in the art would understand that any side of any feature can be named (or not named) in any preferred manner as needed. Additionally, and for the purposes of explanation and reference, each edge can have a first end, a second end, and a center portion between the first and second ends, as shown in FIG. 8, and as referenced in the description of FIGS. 8-13. The mirror structure can be configured to oscillate on an axis of rotation (e.g., 805) that is parallel to and equidistant (e.g., at a distance d) from the first and second edges of the mirror structure. In some embodiments, the mirror structure can include a mirror (e.g., 820) and a gimbal (e.g., 830) coupled to the mirror via a set of connection structures, where the gimbal is configured concentrically around and coplanar with the mirror. When rotated, the gimbal can cause the mirror to rotate on the axis of rotation. In such cases, the first-fourth edges of the mirror structure are part of the gimbal, as shown in FIG. 8. Although the embodiments depicted herein all include a gimbal structure, it should be understood that some embodiments may not employ a gimbal structure, and in such cases the first-fourth edges of the mirror structure may be the edges of the mirror itself, as would be appreciated by one of ordinary skill in the art with the benefit of this disclosure. The system (e.g., 800) can further include at least two torsion springs (e.g., 850) coupled to diametrically opposed ends of the mirror structure along the axis of rotation (e.g., 805), where the torsion springs are configured to apply a rotational force to the mirror structure that causes the mirror structure to oscillate (e.g., at a resonant frequency). The at least two torsion springs can each be coupled to an anchor structure (e.g., 840) that is coupled to the substrate.

FIG. 9 shows a close-up view of a quadrant of MEMS-based mirror assembly 800 driven by piezoelectric actuators with a first type of connection spring, according to certain embodiments. The top-right quadrant shows mirror 820, gimbal 830, piezoelectric actuator 870a, and backside skeleton support structure 860. Mirror 820 and gimbal 830 are coupled together via connection structures 825, and piezoelectric actuator 870a is coupled to gimbal 830 via connection springs 880a-c. For the sake of simplicity in understanding the novel concepts described herein, the various components of micro-mirror assembly 800 are reused in FIGS. 9-13, with main differences including the size and location of the piezoelectric actuators and corresponding connection springs. Referring to FIG. 9, the connection springs have a backwards S-shape with 3 linear sections that are configured to provide flexibility to mitigate temperature-based performance degradation that can adversely affect piezoelectric drives and change the magnitude of the force and torque on the mirror structure, as described above. The connection springs may be dimensioned (e.g., length, width, shape, etc.) as needed based on a natural frequency of the system (e.g., the resonant frequency that the mirror oscillates at). The number of the connection springs depends on the spring dimensions. In an actual design, all the spring length, width, number of the springs and their position along the piezoelectric actuator edge are gradually adjusted in terms of a required natural frequency as well as a specified dynamic deformation. In most cases, S-shaped or backwards S-shaped connection springs are predominantly used to connect the actuators and the mirror. Typically, connection springs are formed as a series of linear structures to form the “L” or “S” shapes (and their backwards variants), as shown for instance in FIGS. 7-12, rather than curved structures, which may be interpreted by the use of the “S” descriptor, although curved variants are possible, as well as alternative shapes not expressly described in this document.

In some embodiments, the connection springs may be co-planar with the mirror structure (e.g., mirror and gimbal; mirror-only, etc.) and can include a plurality of sections. In some backwards S-shaped implementations, the connection springs can be comprised of three linear sections including: a first section protruding from the first edge of the mirror structure in a direction normal to the axis of rotation and oriented towards the first piezoelectric actuator (870a); a second section protruding from the first piezoelectric actuator in a direction normal to the axis of rotation, not collinear with the first section, and oriented towards the mirror structure; and a third section configured parallel to the axis of rotation that couples the first section to the second section. Note that the description above describes the connection springs (first set of connection springs) coupled to the first edge and first piezoelectric actuator. Although not shown, the bottom piezoelectric actuator 870b and corresponding connection springs (second set of connection springs) may be similarly configured such that each connection spring is co-planar with the mirror structure and includes: a first section protruding from the second edge of the mirror structure in a direction normal to the axis of rotation and oriented towards the second piezoelectric actuator; a second section protruding from the second piezoelectric actuator in a direction normal to the axis of rotation, not collinear with the first section protruding from the second edge of the mirror structure, and oriented towards the mirror structure; and a third section configured parallel to the axis of rotation that couples the first section protruding from the second edge of the mirror structure to the second section protruding from the second piezoelectric actuator. In the embodiments shown in FIGS. 7-9, the backwards S-shaped connection springs are configured such that the second section is configured closer to the first end of the second end than the first section. In some embodiments, the connection structures may be placed symmetrically along the first edge in opposite groups of two (e.g., connection structures (a, l), (b, k), (c, j)). Alternatively, connection structures may be placed asymmetrically and may or may not have opposite pairs.

FIG. 10 shows a close up-view of a quadrant of a MEMS-based mirror structure driven by piezoelectric actuators with a second type of connection spring, according to certain embodiments. The top-right quadrant shows mirror 820, gimbal 830, piezoelectric actuator 870a, and backside skeleton support structure 860. Mirror 820 and gimbal 830 are coupled together via connection structures 825, and piezoelectric actuator 870a is coupled to gimbal 830 via connection springs 882a-c. In FIG. 10, the connection structures are similar to connection structures 880a-c, but in an opposite configuration that can be described as an “S-shaped” implementation. In this configuration, the first section is configured closer to the first end or the second end than the second section. In some embodiments, the connection structures may be placed symmetrically along the first edge in opposite groups of two, as described above with respect to FIG. 9, or they may be placed asymmetrically and may or may not have opposite pairs.

FIG. 11 shows a close up view of a quadrant of a MEMS-based mirror structure driven by piezoelectric actuators with a third type of connection spring, according to certain embodiments. The top-right quadrant shows mirror 820, gimbal 830, piezoelectric actuator 872, and backside skeleton support structure 860. Mirror 820 and gimbal 830 are coupled together via connection structures 825, and piezoelectric actuator 872, which is now configured on the fourth edge of the mirror structure (on a “vertical side” of the mirror structure), couples to gimbal 830 via connection spring 884. Connection spring 884 is shown as an L-shaped beam. The L-shaped connection spring 884 can be co-planar with the mirror structure and can include a first section protruding from the fourth edge of the mirror structure in a direction parallel to and not collinear with the axis of rotation and oriented towards the second piezoelectric actuator; and a second section protruding from the second piezoelectric actuator in a direction normal to the axis of rotation that couples to an end portion of the first section protruding from the fourth edge of the mirror structure. As shown in FIG. 11, the second section couples to piezoelectric actuator 872 at or close to a location where the first edge and fourth edge of the mirror structure meet. Although one piezoelectric actuator 872 and one connection spring 884 are shown, each quadrant may include one or more piezoelectric actuators and corresponding connection springs as would be appreciated by one of ordinary skill in the art with the benefit of this disclosure.

FIG. 12 shows a close up view of a quadrant of a MEMS-based mirror structure driven by piezoelectric actuators with a fourth type of connection spring, according to certain embodiments. The top-right quadrant shows mirror 820, gimbal 830, piezoelectric actuator 874, and backside skeleton support structure 860. Mirror 820 and gimbal 830 are coupled together via connection structures 825, and piezoelectric actuator 874, which is now configured on the fourth edge of the mirror structure (on a “vertical side” of the mirror structure), couples to gimbal 830 via connection spring 886. Connection spring 886 is shown as an L-shaped beam that is opposite to connection spring 884. The L-shaped connection spring 886 can be co-planar with the mirror structure and can include a first section protruding from the fourth edge of the mirror structure in a direction parallel to and not collinear with the axis of rotation and oriented towards the second piezoelectric actuator; and a second section protruding from the second piezoelectric actuator in a direction normal to the axis of rotation that couples to an end portion of the first section protruding from the fourth edge of the mirror structure. As noted above, each edge can have a first and second end and a center portion configured there between. As shown in FIG. 12, the second section couples to piezoelectric actuator 874 at a location closer to the center portion than to the first or second ends of the fourth edge. Although one piezoelectric actuator 874 and one connection structure 886 are shown, each quadrant may include one or more piezoelectric actuators and corresponding connection springs configured in a similar manner, as would be appreciated by one of ordinary skill in the art with the benefit of this disclosure.

In some exemplary embodiments, a MEMS-based semiconductor integrated circuit for a LiDAR system with piezoelectric actuators on the third and fourth edges (as shown in FIGS. 7 and 11-13) can include a substrate, a first piezoelectric actuator coupled to the substrate, a second piezoelectric actuator (872) coupled to the substrate, and a mirror structure configured between the first piezoelectric actuator and the second piezoelectric actuator. The mirror structure can be planar, having a length and a width, and may include a first edge defining the length of the mirror structure, a second edge defining the length of the mirror structure and opposing the first edge, a third edge defining the width of the mirror structure, and a fourth edge defining the width of the mirror structure and opposing the third edge, like shown in FIG. 8. In some aspects, the third edge is coupled to the first piezoelectric actuator via a first set of connection springs and the fourth edge is coupled to the second piezoelectric actuator via a second set of connection springs (e.g., 884 or 886). The mirror structure may be configured to oscillate on an axis of rotation that is parallel to and equidistant from the first and second edges of the mirror structure, and normal to the third and fourth edges of the mirror structure, similar to the mirror structure shown in FIG. 8. In some aspects, the mirror structure can include a mirror and a gimbal coupled to the mirror via a set of connection structures, where the gimbal is configured concentrically around and coplanar with the mirror. When rotated, the gimbal can cause the mirror to rotate. The first, second, third, and fourth edges of the mirror structure may be a part of the gimbal. In some cases, each connection spring in the first set of connection springs can be co-planar with the mirror structure and includes a first section protruding from the third edge of the mirror structure in a direction parallel to and not collinear with the axis of rotation and oriented towards the first piezoelectric actuator, and a second section protruding from the first piezoelectric actuator in a direction normal to the axis of rotation that couples to an end portion of the first section protruding from the third edge of the mirror structure. In some cases, each connection spring in the second set of connection springs is co-planar with the mirror structure and includes a first section protruding from the fourth edge of the mirror structure in a direction parallel to and not collinear with the axis of rotation and oriented towards the second piezoelectric actuator, and a second section protruding from the second piezoelectric actuator in a direction normal to the axis of rotation that couples to an end portion of the first section protruding from the fourth edge of the mirror structure. In some aspects, the second section couples to the first piezoelectric actuator at a location where the first edge and fourth edge of the mirror structure meet. In some aspects, the third edge of the mirror structure has a first end, a second end, and a center portion between the first and second ends of the fourth edge, and the second section couples to the first piezoelectric actuator at a location closer to the center portion than to the first or second ends of the fourth edge. The system can further include at least two torsion springs coupled to diametrically opposed ends of the mirror structure along the axis of rotation, where the torsion springs are configured to apply a rotational force to the mirror structure that causes the mirror structure to oscillate (e.g., at a resonant frequency). The at least two torsion springs can each be coupled to an anchor structure that is coupled to the substrate.

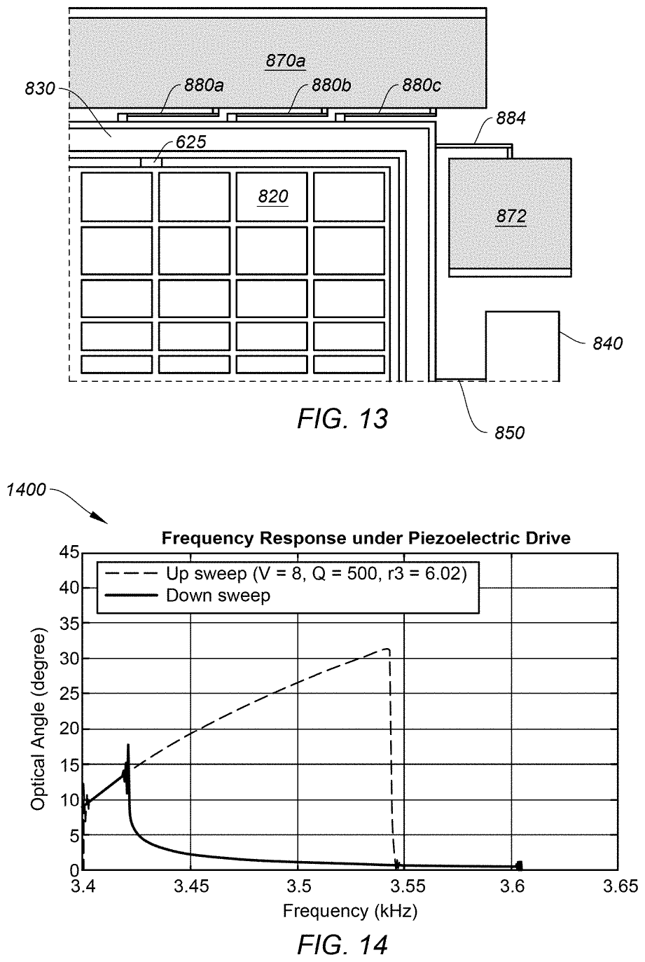

FIG. 13 shows a close-up view of a quadrant of a MEMS-based mirror structure driven by piezoelectric actuators with multiple types of connection springs, according to certain embodiments. Both horizontally configured piezoelectric actuators (e.g., 870a) and vertically configured actuators (e.g., 872) can provide additional torque and a greater mirror angle of deflection and corresponding field-of-view.

FIG. 14 is a graph 1400 showing frequency response curves of a MEMS-based mirror structure driven by a piezoelectric actuator system, according to certain embodiments. The drive voltage is 8V, the air quality factor “Q” is 500, and the optical angle may achieve 30 degrees or more. The above numbers are typical nominal values and depending on a specific design and a specific application, the numerical values could significantly vary. For example, the drive voltage on piezoelectric actuators could be as high as 100V, Q could be anywhere from 50 to 5000, etc. One of ordinary skill in the art with the benefit of this disclosure would appreciate the many modifications, variations, and alternative embodiments thereof.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A Light Detection and Ranging (LiDAR) module for a vehicle, the LiDAR module comprising:
a semiconductor integrated circuit including a microelectromechanical system (MEMS), the MEMS including:
a substrate;
a first piezoelectric actuator coupled to the substrate;
a second piezoelectric actuator coupled to the substrate; and
a mirror structure configured between the first piezoelectric actuator and the second piezoelectric actuator, the mirror structure being planar, having a length and a width, and including:
a first edge defining the length of the mirror structure, wherein the first edge is coupled to the first piezoelectric actuator via a first set of connection springs;
a second edge defining the length of the mirror structure and opposing the first edge, wherein the second edge is coupled to the second piezoelectric actuator via a second set of connection springs;
a third edge defining the width of the mirror structure; and
a fourth edge defining the width of the mirror structure and opposing the third edge,
wherein the mirror structure is configured to oscillate on an axis of rotation that is parallel to and equidistant from the first and second edges of the mirror structure.

2. The LiDAR module of claim 1 wherein the mirror structure comprises:
a mirror; and
a gimbal coupled to the mirror via a set of connection structures, wherein the gimbal is configured concentrically around and coplanar with the mirror, wherein when rotated, the gimbal causes the mirror to rotate,
wherein the first and second edges of the mirror structure are part of the gimbal.

3. The LiDAR module of claim 1 wherein each connection spring in the first set of connection springs is co-planar with the mirror structure and includes:
a first section protruding from the first edge of the mirror structure in a direction normal to the axis of rotation and oriented towards the first piezoelectric actuator;
a second section protruding from the first piezoelectric actuator in a direction normal to the axis of rotation, not collinear with the first section, and oriented towards the mirror structure; and
a third section configured parallel to the axis of rotation that couples the first section to the second section.

4. The LiDAR module of claim 3 wherein each connection spring in the second set of connection springs is co-planar with the mirror structure and includes:
a first section protruding from the second edge of the mirror structure in a direction normal to the axis of rotation and oriented towards the second piezoelectric actuator;
a second section protruding from the second piezoelectric actuator in a direction normal to the axis of rotation, not collinear with the first section protruding from the second edge of the mirror structure, and oriented towards the mirror structure; and
a third section configured parallel to the axis of rotation that couples the first section protruding from the second edge of the mirror structure to the second section protruding from the second piezoelectric actuator.

5. The LiDAR module of claim 3 wherein the first edge of the mirror structure has a first end, a second end, and a center portion between the first and second ends,
wherein the second section is configured closer to the first end or the second end than the first section.

6. The LiDAR module of claim 3 wherein the first edge of the mirror structure has a first end, a second end, and a center portion between the first and second ends,
wherein the first section is configured closer to the first end or the second end than the second section.

7. The LiDAR module of claim 3 further comprising at least two torsion springs coupled to diametrically opposed ends of the mirror structure along the axis of rotation, wherein the torsion springs are configured to apply a rotational force to the mirror structure that causes the mirror structure to oscillate.

8. The LiDAR module of claim 7 wherein the at least two torsion springs are each coupled to an anchor structure, the anchor structure being coupled to the substrate.

9. A Light Detection and Ranging (LiDAR) module for a vehicle, the LiDAR module comprising:
a semiconductor integrated circuit including a microelectromechanical system (MEMS), the MEMS including:
a substrate;
a first piezoelectric actuator coupled to the substrate;
a second piezoelectric actuator coupled to the substrate; and
a mirror structure configured between the first piezoelectric actuator and the second piezoelectric actuator, the mirror structure being planar, having a length and a width, and including:
a first edge defining the length of the mirror structure;
a second edge defining the length of the mirror structure and opposing the first edge;
a third edge defining the width of the mirror structure, wherein the third edge is coupled to the first piezoelectric actuator via a first set of connection springs; and
a fourth edge defining the width of the mirror structure and opposing the third edge, wherein the fourth edge is coupled to the second piezoelectric actuator via a second set of connection springs,
wherein the mirror structure is configured to oscillate on an axis of rotation that is parallel to and equidistant from the first and second edges of the mirror structure, and normal to the third and fourth edges of the mirror structure.

10. The LiDAR module of claim 9 wherein the mirror structure comprises:
a mirror; and
a gimbal coupled to the mirror via a set of connection structures, wherein the gimbal is configured concentrically around and coplanar with the mirror, wherein when rotated, the gimbal causes the mirror to rotate,
wherein the third and fourth edges of the mirror structure are part of the gimbal.

11. The LiDAR module of claim 9 wherein each connection spring in the first set of connection springs is co-planar with the mirror structure and includes:
a first section protruding from the third edge of the mirror structure in a direction parallel to and not collinear with the axis of rotation and oriented towards the first piezoelectric actuator; and
a second section protruding from the first piezoelectric actuator in a direction normal to the axis of rotation that couples to an end portion of the first section protruding from the third edge of the mirror structure.

12. The LiDAR module of claim 11 wherein each connection spring in the second set of connection springs is co-planar with the mirror structure and includes:
a first section protruding from the fourth edge of the mirror structure in a direction parallel to and not collinear with the axis of rotation and oriented towards the second piezoelectric actuator; and
a second section protruding from the second piezoelectric actuator in a direction normal to the axis of rotation that couples to an end portion of the first section protruding from the fourth edge of the mirror structure.

13. The LiDAR module of claim 11 wherein the second section couples to the first piezoelectric actuator at a location where the first edge and third edge of the mirror structure meet.

14. The LiDAR module of claim 11 wherein the third edge of the mirror structure has a first end, a second end, and a center portion between the first and second ends of the third edge,
wherein the second section couples to the first piezoelectric actuator at a location closer to the center portion than to the first or second ends of the third edge.

15. The LiDAR module of claim 11 further comprising at least two torsion springs coupled to diametrically opposed ends of the mirror structure along the axis of rotation, wherein the torsion springs are configured to apply a rotational force to the mirror structure that causes the mirror structure to oscillate.

16. The LiDAR module of claim 15 wherein the at least two torsion springs are each coupled to an anchor structure, the anchor structure being coupled to the substrate.

17. A Light Detection and Ranging (LiDAR) module for a vehicle, the LiDAR module comprising:
a semiconductor integrated circuit including a microelectromechanical system (MEMS), the MEMS including:
a substrate;
a first piezoelectric actuator coupled to the substrate;
a second piezoelectric actuator coupled to the substrate; and
a mirror structure configured between the first piezoelectric actuator and the second piezoelectric actuator, the mirror structure being planar, having a length and a width, and including:
a first edge defining the length of the mirror structure, wherein the first edge is coupled to the first piezoelectric actuator via a first set of connection springs;
a second edge defining the length of the mirror structure and opposing the first edge;
a third edge defining the width of the mirror structure; and
a fourth edge defining the width of the mirror structure and opposing the third edge, wherein the fourth edge is coupled to the second piezoelectric actuator via a second set of connection springs,
wherein the mirror structure is configured to oscillate on an axis of rotation that is parallel to and equidistant from the first and second edges of the mirror structure, and normal to the third and fourth edges of the mirror structure.

18. The LiDAR module of claim 17 wherein each connection spring in the first set of connection springs is co-planar with the mirror structure and includes:
a first section protruding from the first edge of the mirror structure in a direction normal to the axis of rotation and oriented towards the first piezoelectric actuator;
a second section protruding from the first piezoelectric actuator in a direction normal to the axis of rotation, not collinear with the first section, and oriented towards the mirror structure; and
a third section configured parallel to the axis of rotation that couples the first section to the second section for each connection spring of the first set of connection springs, and
wherein each connection spring in the second set of connection springs is co-planar with the mirror structure and includes:
a first section protruding from the fourth edge of the mirror structure in a direction parallel to and not collinear with the axis of rotation and oriented towards the second piezoelectric actuator; and
a second section protruding from the second piezoelectric actuator in a direction normal to the axis of rotation that couples to an end portion of the first section protruding from the fourth edge of the mirror structure.

19. The LiDAR module of claim 17 further comprising at least two torsion springs coupled to diametrically opposed ends of the mirror structure along the axis of rotation, wherein the torsion springs are configured to apply a rotational force to the mirror structure that causes the mirror structure to oscillate.

20. The LiDAR module of claim 19 wherein the at least two torsion springs are each coupled to an anchor structure, the anchor structure being coupled to the substrate.
